(19) United States
(12) Patent Application Publication
(10) Pub. No.: US 2009/0252863 A1
(43) Pub. Date: Oct. 8, 2009

(54) METHOD OF MANUFACTURING PROTECTION FILM AND METHOD OF MANUFACTURING INORGANIC FILM

(75) Inventor: Tatsuya Yoshizawa, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/996,277

(22) PCT Filed: Jul. 3, 2006
(86) PCT No.: PCT/JP2006/313242

§ 371 Date: Jan. 18, 2008

(30) Foreign Application Priority Data
Jul. 19, 2005 (JP) 2005-208349

(51) Int. Cl. B05D 5/12; B05D 3/00

(52) U.S. Cl. 427/66; 427/331; 427/58

(57) ABSTRACT

There is provided is a method of manufacturing a protection film or a method of manufacturing an inorganic film, wherein density of the inorganic film is sufficient.

In the method of manufacturing a barrier film 12 and a sealing film 20 as protection films for protecting an organic EL element 100 and an organic TFT 50, a pre-oxidized inorganic film 120, being not completely oxidized, is formed and the oxidized inorganic film 120 thus formed is oxidized to thereby form a part of the protection film.

### TECHNICAL FIELD

The present invention relates to a method of manufacturing a protection film and a method of manufacturing an inorganic film, particularly a protection film or an inorganic film which includes at least one layer of oxidized inorganic film.

### BACKGROUND ART

The organic EL element is provided with electrodes on a substrate and an organic solid layer having at least a luminescent layer between the electrodes, wherein electrons and electron holes are injected into the luminescent layer from the both-side electrodes to emit light in the organic luminescent layer and high intensity luminescence is available. Further it features wide selection of luminescent colors because luminescence of the organic compounds is utilized, and therefore it is expected as a light source and an organic EL display device. Particularly, since the organic EL display device ordinarily has high visibility field, high visibility, high contrast, high-speed responsibility, excellent visibility, and thin shape and light weight, it is expected as a low-power-consumption flat panel display.

Generally, the organic EL display device includes pixels having at least a positive electrode, an organic luminescent layer, a negative electrode and an element e.g. a transistor for lighting and controlling the organic EL element. There are two types of driving organic EL display devices - a passive matrix method and an active matrix method. In the passive matrix method, the organic EL elements arranged in a matrix shape are driven from outside by a stripe-like scan electrode and data electrode (signal electrode) which are perpendicular to each other. In the active matrix method, a driving element, a memory element, and a switching element formed of thin film transistor (also refereed to as TFT hereinafter) every pixel are provided to light the organic EL element.

With the increasing number of pixels, ordinarily, the active matrix method for driving the organic EL element with TFT (thin film Transistors) is considered more advantageous for the organic EL display device than the passive matrix method is. This is because, by the passive matrix method, the organic EL element of each pixel is lit during the period a scanning electrode is selected, and the period for lighting the organic EL element tends to decrease to lower average luminance as the number of pixels increases. On the contrary by the active matrix method, each pixel has a memory element and a switching element formed of TFT, lighting state of the organic EL element is kept, high luminance, high efficiency and long life operation are possible, and the active matrix method tends to be advantageous for displays of high resolution and enlarged size.

Here, use of the organic TFT for TFT may lead to reduction of costs and environment load. Further since the organic TFT can be produced at low process temperature, it may be produced on film substrates and therefore flexible displays are expected to be realized.

With regard to organic EL elements and organic TFTs, they are susceptible to erosion caused by moisture and oxygen in the air. In the presence of such moisture and oxygen, there may occur deterioration such as dark-spot and element short. A means for protecting elements from erosion due to moisture and oxygen in the air is necessary to protect from this deterioration. At the present, there is employed a method that elements are entirely sealed with cover glass and can packages in the atmosphere of argon gas and dry nitrogen.

However, production costs of this sealing method using glass and cans are high and there is limitation to decrease an element thickness. Then, a configuration in which organic ELEL elements and organic TFT are covered with protection films having a moisture-prevention function without using glass and can packages is proposed in Patent Document 1 described below.

It is ordinary that the protection film for protecting elements from exterior factors causing damage such as moisture and oxygen comprises not only organic EL elements and organic TFTs but also inorganic films.

Patent Document 1 : Japanese Patent Unexamined Publication No. JP-A-2003-255857

### DISCLOSURE OF THE INVENTION

### Problems to be Solved by the Invention

However, in the inorganic film, density is not sufficient in some cases because pinholes partially occur. When pinholes partially occur and density is not sufficient, moisture, oxygen and others penetrate the element surface from outside through pinholes generated in this inorganic film, thereby causing damage to the elements. Further in a case where an inorganic film includes a protection film, outgas generated in the inorganic film penetrates the element surface through pinholes generated in the inorganic film, thereby causing damage to the elements.

The present invention is provided in consideration of the above problems and the object of the present invention is to provide a method of manufacturing a protection film and a method of manufacturing an inorganic film which have sufficient density.

### Means for Solving Problems

To solve the above-mentioned problem, according to claim 1 of the present invention, there is provided a method of manufacturing a protection film protecting elements and containing at least one layer of oxidized inorganic film, including:

a pre-oxidized inorganic film formation step of forming a pre-oxidized inorganic film which is not completely oxidized; and

an inorganic film oxidation step of oxidizing the pre-oxidized inorganic film to form the oxidized inorganic film.

To solve the above-mentioned problem, according to claim 9 of the present invention, there is provided a method of manufacturing an inorganic film which includes at least one layer of oxidized inorganic film, including:

a pre-oxidized inorganic film formation step of forming a pre-oxidized inorganic film which is not completely oxidized; and

an inorganic film oxidation step of oxidizing the pre-oxidized inorganic film at least partially to form the oxidized inorganic film.

### BRIEF DESCRIPTION OF THE DRAWINGS

FIG. 1 A schematic cross sectional view showing an organic EL display device related to the present embodiment

FIG. 2 A schematic enlarged view of around an organic EL element of the organic EL display device according to the present embodiment

FIG. 3 A schematic enlarged view of around an organic TFT of the organic EL display device according to the present embodiment

FIG. 4 A schematic view explaining a method of manufacturing a protection film according to the present embodiment

FIG. 5 A schematic view explaining a method of manufacturing a protection film according to the present embodiment

FIG. 6 A schematic view explaining a method of manufacturing a protection film according to the present embodiment

FIG. 7 A schematic view explaining a method of manufacturing a protection film according to the present embodiment

FIG. 8 A schematic view explaining a method of manufacturing a protection film according to the present embodiment

FIG. 9 A schematic view explaining a method of manufacturing a protection film according to the present embodiment

FIG. 10 A schematic view explaining a method of manufacturing a protection film according to the present embodiment

### DESCRIPTION OF REFERENCE NUMERALS

10: Substrate;
16: Organic solid layer;
18: Negative electrode;
20: Protection film;
50: Organic TFT;
100: Organic EL element; and
P: Organic EL display device

### BEST MODES FOR CARRYING OUT THE INVENTION

### [Study on Density Improvement]

The present inventor had examined to prevent components such as moisture, oxygen, and outgas which damage elements from penetrating elements through pinholes made on inorganic films. As a result, it is surprisingly found that, when pre-oxidized inorganic films are oxidized after the pre-oxidized inorganic films which are not completely oxidized are formed, oxidized films are produced as if implanting the pinholes, decrease pinhole width, and completely cover in the pinholes in some cases.

In application of this phenomenon, protection films are manufactured by forming pre-oxidized inorganic films which are not completely oxidized. Subsequently, these pre-oxidized inorganic films are oxidized. As a result, it is found possible to prevent damaging components from penetrating elements through pinholes because of decreased pinhole width, and further possible to contribute to improvement of element reliability.

Moreover, ordinarily in inorganic films which become useful by improving their density, the present inventor also found a phenomenon that pre-oxidized inorganic films which are not completely oxidized are formed, subsequently these pre-oxidized inorganic films are oxidized, oxide films are generated to implant pinholes, and therefore these oxide films increase in cubic volume (oxide development) compared with pre-oxidized inorganic films, and thereby pinhole width decreases and pinholes are completely covered in some cases.

Meanwhile, “oxidation” in the present invention has not only a narrow meaning of oxidation by oxygen but also a broad meaning of oxidation expressed by increasing oxidation number against metals. Therefore, oxidation has not only a narrow meaning of oxidation by oxygen but also a broad meaning of increasing oxidation number of metals, such as nitridation and sulfuridation.

Furthermore, the present inventor found the phenomenon that even though pinholes do not exist in an inorganic film itself but in the adjacent inorganic film, oxide development occur to implant pinholes in the adjacent inorganic film by oxidation of the inorganic film to be oxidized, and therefore the number and width of pinholes decrease and pinholes are completely covered in some cases.

### [Organic EL Display Device]

Hereinafter, an embodiment of the present invention is described with reference to drawings. The preset embodiment is just as exemplification to practice the present invention, and the present invention is not limited to the present embodiment.

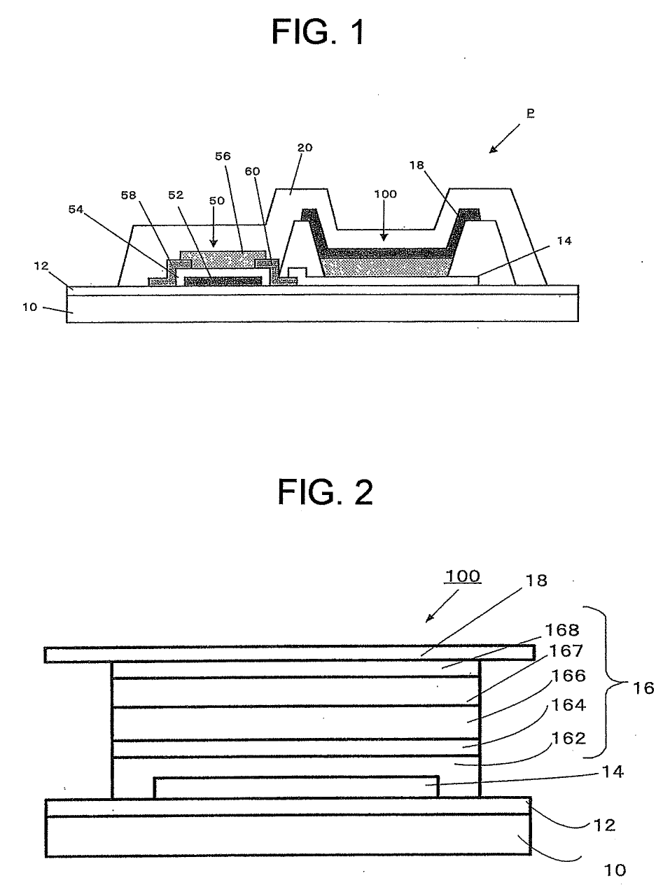

FIG. 1 is a schematic cross sectional view showing an organic EL display device according to the present embodiment. The organic EL display device P includes a film substrate 10, a barrier film 12 formed on the substrate 10, an organic EL element 100 and an organic TFT 50 which are formed on the barrier film 12, and a sealing film 20 which covers the organic TFT 50 and protects the organic EL element 100 and the organic TFT 50 from erosion from outside. The barrier film 12 and the sealing film 20 are both protection films.

### <Substrate>

Materials of the substrate 10 may be appropriately selected. For example, resins used for a variety of substrates may include thermoplastic resin, thermoset resin, polycarbonate, polymethylmethacrylate, polyarylether, polyethersulfone, polysulfone, polyethylene terephthalate polyester, polypropylene, cellophane, polycarbonate, acetylcellulose, polyethylene, polyvinyl chloride, polystyrene, polyamidee, polyimidee, polyvinylidene chloride, polyvinyl alcohol, ethylene-vinyl acetate copolymer saponifiables, fluororesin, chlorinated rubber, ionomer, ethylene acrylic copolymer, ethylene acrylic ester copolymer. Further, resins are not principal ingredient for substrates but substrates may be glass substrates, or substrates or metal plate laminated with glass and plastic, or substrate surfaces may be covered with an alkali barrier film or a gas barrier film. Further, in a case of a top emission type of irradiating light to transparent substrates from an opposite side, a substrate 10 may not be necessarily transparent.

### <Barrier Film>

Although an organic film and an inorganic film are used at the same time for the barrier film 12 only in the present embodiment, single application of an inorganic film is possible. Materials of the barrier film 12 may be appropriately selected. The barrier film 12 is one type of protection films.

The barrier film 12 may be of a multilayer structure or a single layer structure, and an inorganic film or an organic film. However, it is preferable to include the inorganic film because it improves barrier performance of preventing erosion by moisture and oxygen.

As for the inorganic film, nitride film, oxide film, carbon film, or silicon film are exemplified. Specifically, silicon nitride film, silicon oxide film, silicon oxide nitride film, or diamond-like carbon (DLC) film, and amorphous carbon film are exemplified. That is, nitride such as SiN, AlN, GaN, oxides such as SiO, Al₂O₃, Ta₂O₅, ZnO, GeO, oxide nitride such as SiON, carbide nitride such as SiCN, metal fluoride, and metal film. Here amorphous silicon film is preferable.

As for the organic film, furan film, pyrrole film, thiophene film, or polymerized film such as polyparaxylene film epoxy resin, acrylic resin, polyparaxylene, fluoroine polymer (perfluoroolefin, perfluoroether, tetrafluoroethylene, chlorotrifluoroethylene, dichlorodifluoroethylene.), metal alkoxido (CH₃OM, C₂H₅OM), polyamidee precursor and peril compound are exemplified.

As for the barrier film 12, a laminated structure including two and more types of materials, a laminated structure including inorganic protection film, silane coupling layer and resin sealing film, a laminated structure including a barrier layer formed of inorganic material and a cover layer formed of organic material, a laminated structure including a compound of organics and semiconductor or metals such as Si—CXHY, and inorganics, a laminated structure in which organic and inorganic films are alternately laminated and a laminated structure in which SiO₂ or Si₃N₄ is laminated on a Si layer are exemplified.

### <Organic EL Element>

FIG. 2 is an enlarged view showing the organic EL element 100 of the organic EL display device P and its vicinity. The organic EL element 100 is configured by the positive electrode 14, the organic solid layer 16, and the negative electrode 18, laminated in this order from a side of the barrier film 12.

As for the positive electrode 14, it is sufficient to use the layer having an energy level enabling to easily inject electron holes. A transparent electrode such as ITO (indium tin oxide film) may be used. In a case where the top emission type of the organic EL display device, ordinary electrodes may be employed instead of transparent electrodes.

The transparent conductive material such as ITO is formed into a thickness of e.g. 150 nm by spattering and by others methods. A zinc oxide (ZnO) film, IZO (indium zinc alloy oxide), gold, copper iodide, or the like may be employed instead of ITO, but the material is not limited thereto.

The organic solid layer 16 is made of an electron hole injection layer 162, an electron hole transport layer 164, a luminescent layer 166, an electron transport layer 167, and an electron injection layer 168 which are laminated in order from a side of the positive electrode 14.

The electron hole injection layer 162 is provided between the positive electrode 14 and the electron hole transport layer 164 and is a layer for promoting electron hole injection from the positive electrode 14. The driving voltage of the organic EL element 100 can be lowered by the electron hole injection layer 162. Further, in some cases, the electron hole injection layer 162 works to stabilize electron hole injection so as to lengthen the service life of elements, and works to coat convex-concave surfaces such as projection formed on the surface of the active electron 14 so as to decrease element defects.

Materials of the electron hole injection layer 162 may be selected to meet requirement that its ionized energy is between the work function of the positive electrode 14 and the ionized energy of the electron hole transport layer 164. For example, triphenylamin tetrameric (TPTE), and copper phthalocyanine may be used.

The electron hole transport layer 164 is provided between the electron hole injection layer 162 and the luminescent layer 166 for promoting electron hole transportation and has a function to appropriately transport electron holes to the luminescent layer 166.

It is only necessary to suitably select materials of the electron hole transport layer 164 so that its ionized energy is located between the electron hole injection layer 162 and the luminescent layer 166. For example, TPD (triphenylamin derivative) and NPB (N,N-di(naphthalene-1-yl)-N, N-diphenyl-benzidne) may be employed.

The luminescent layer 166 is a layer to recombine the electron hole thus transported and the electron described later which is transported as well to emit fluorescence or phosphorescence. Materials of the luminescent layer 166 may be selected so as to satisfy the characteristics to correspond to the above-mentioned luminous mode. For example, π-conjugated polymers including Torris (8-quinolinorate) aluminum complex (Alg), bis (benzoquinolinolato) beryllium complex (BeBq), tri(dibenzoyl methyl) phenanthroline europium complex (Eu(DBM)3(Phen)), ditholilvinylbiphenyl (DTVBi), poly (p-phenylenevinylene), and polyalkylthiophene may be used. For example, if green luminescence is desired, alumiquinolinol complex (Alq₃) may be used.

The electron transport layer 167 is provided between the luminescent layer 166 and the electron injection layer 168 and has a function to promote electron transportation into the luminescent layer 166. As for the electron transport layer 167, for example, alumiquinolinol complex (Alq₃) may be used.

The electron injection layer 168 is provided between the electron transport layer 167 and the negative electrode 18 and has a function to promote electron injection from the negative electrode 18.

Materials of the electron transport layer 168 may be appropriately selected so that electron affinity is located between work function of the negative electrode 18 and an electron affinity of the luminescent layer 166. For example, a thin film (e.g. 0.5 mm) formed of Lif(lithium fluoride), Li₂O(Lithium oxide) may be employed for the electron transport layer 168.

Each layer forming these organic solid layers 16 is ordinarily made of organics, particularly made of low-molecular organics and made of high molecular organics. As a method of forming the organic solid layer 16, for example, low-molecular organics may be ordinarily formed by dry process (vacuum process) such as vapor deposition method, and high-molecular organics may be ordinarily formed by wet process such as spincoating method, plate coating method, dipping method, spraying method and printing method.

As for organic materials used for each layer forming the organic solid layer 16, there are included PEDOT, polyaniline, polyparaphenilanevinylen derivative, polythiophene derivative, polyparaphenylane derivative, polyalkylphenilane, and polyacetylene derivative.

According to the present invention, the organic solid layer 16 includes the electron hoe injection layer 162, the electron hole transport layer 164, the luminescent layer 166, the electron transport 167, and the electron injection layer 168. However, the organic solid layer is not limited thereto as long as the configuration may include at least the luminescent layer 166.

For example, a single-layer structure of the luminescent layer, a double-layer structure such as electron hole transport layer/luminescent layer, luminescent layer/electron transport layer, and a triple-layer structure of electron hole transport layer/luminescent layer/electron transport layer, and further a multiple-layer structure which includes an electric charge (electron hole, electron) injection layer may be formed depending on characteristics of employed organic materials.

Further, the organic solid layer 16 may be provided with an electron hole blocking layer between the luminescent layer 166 and the electron transport layer 167. The electron holes possibly penetrate through the luminescent layer 166 and reaches the negative electrode 18. For example, in case of using Alq₃ for the electron transport layer 168, there is possibility that luminescence efficiency decreases because electron holes flow into the electron transport layer to make Alq₃ emit luminescence and therefore the electron holes cannot be blocked in the luminescent layer. Therefore, the electron hole blocking layer may be provided to prevent electron holes from flowing out of the luminescent layer 166 to the electron transport layer 168.

As for the negative electrode 18, it is only necessary to select materials having low work function or low electron affinity to enhance electron injection into the organic solid layer 16. For example, alloy type (mixed metal) such as Mg:Ag alloy and Al:Li alloy may be preferably used. The negative electrode 18 may be formed of metal materials such as Al, Mg, and Ag, subjected to vacuum deposition so as to have a thickness of for example 150 mm.

### <Organic Transistor (Organic TFT)>

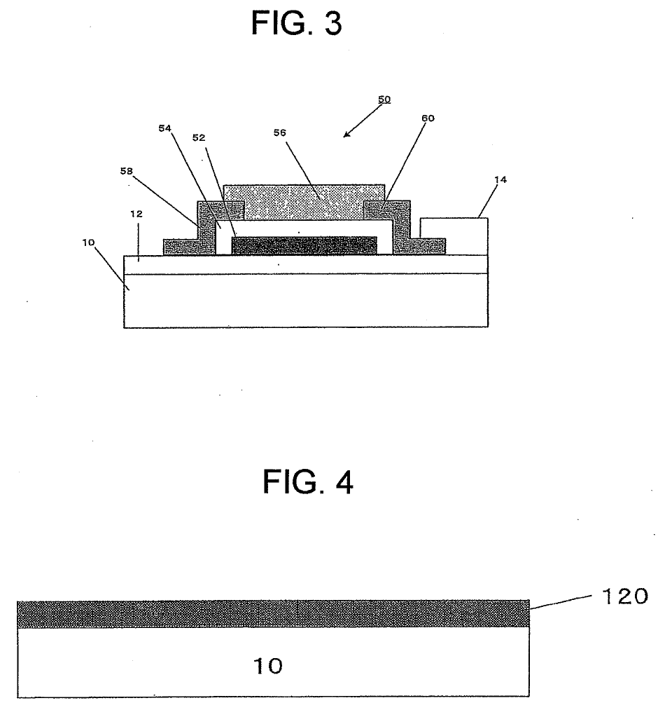

FIG. 3 is an enlarged view showing an organic TFT 50 of the organic EL display device P and its vicinity. The organic TFT 50 has a gate electrode 52 which is formed on the barrier film 12 from the side of the barrier film 12 and a gate insulation film 54 which is formed to cover the surface of the gate electrode 52.

An organic semiconductor layer 56 is formed on the gate insulation film 54, a source electrode 58 is formed on the left end side, and a drain electrode 60 is formed on the right end side. Here the drain electrode 60 is electrically connected to the positive electrode 14 of the organic EL element 100. That is, in the configuration of the organic TFT 50, the source electrode 58 and the drain electrode 60 are provided separately from each other, the organic semiconductor 56 is provided between the source electrode 58 and the drain electrode 60, the source electrode 58, the drain electrode 60 and the organic semiconductor 56 are arranged so as to oppose the gate electrode 52 through the gate insulation film 54.

As materials of the gate electrode 52, metals capable of being anodized and simple substances or their alloys of Al, Mg, Ti, Nb, and Zr may be used. However the material is not limited thereto. As a gate electrode, materials having sufficient conductivity are metal single substances, lamination or their compounds such as Pt, Au, W, Ru, Ir, Al, Sc, Ti, V, Mn, Fe, Co, Ni, Zn, Ga, Y, Zr, Nb, Mo, Tc, Rh, Pd, Ag, Cd, Ln, Sn, Ta, Re, Os, Tl, Pb, La, Cc, Pr, Nd, Pm, Sm, Eu, Gd, Tb, Dy, Ho, Er, Tm, Yb and Lu may be used. Further, organic conductive materials containing conjugated polymer compounds of metal oxide compounds such as ITO and IZO, polyaniline, polythiophene, and polypyrrole may be used.

A manufacturing method of the gate electrode 52a may be an ordinary method for forming a wiring pattern on the substrate 10. Although a spattering method, CVD method and others may be considered, the methods are not limited thereto and appropriate methods may be used. For example, ordinary methods of forming film such as film vacuum deposition, ion plating, sol-gel method, spin coating method, spraying method, and CVD may also be applicable.

With respect to the gate insulation film 54, a surface of a material used as one of the gate electrode 52 may be anodized to form the gate insulation film 54. The film is not limited thereto but either inorganic material or organic material may be used. Further, the insulation film is not limited to metal oxides, but may be sulfide such as FeS, Al₂S₃, MgS, and ZnS, fluoride such as LiF, MgF₂, and SmF₃, chloride such as HgCl, FeCl₂, CrCl₃, bromide such as AgBr, CuBr, MnBr₂, iodide such as PbI₂, CuI, FeI₂, and metal oxide nitride such as SiAlON. Further, it is not limited to metals and metal compounds but may be organic materials such as polymer-system materials including polyimide, polyamide, polyester, polyacrylate, epoxyresin, phenol resin, and poly vinyl alcohol.

A manufacturing method of the gate insulation film 54 is not specifically limited and an appropriate method may be used. For example, although there mentioned a spattering method, CVD method and others, film forming methods ordinarily used like vacuum deposition, ion plating, sol-gel method, spin coating method, spraying method, and CVD may also be used. As for organic films, spin coating method, printing methods, vacuum deposition method, and others may be employed.

Materials for the source electrode 58 and/or the drain electrode 60 are not specifically limited, but ones having sufficient conductivity may be used. For example, metal single substances, lamination or compounds thereof such as Pt, Au, W, Ru, Ir, Al, Sc, Ti, V, Mn, Fe, Co, Ni, Zn, Ga, Y, Zr, Nb, Mo, Tc, Rh, Pd, Ag, Cd, Ln, Sn, Ta, Re, Os, Tl, Pb, La, Ce, Pr, Nd, Pm, Sm, Eu, Gd, Tb, Dy, Ho, Er, Tm, Yb and Lu may be used. Further, organic conductive materials containing conjugated polymer compounds of metal oxide compounds such as ITO and IZo, polyaniline, polythiophene, and polypyrrole may be used.

The source electrode 58 and the drain electrode 60 may be manufactured by methods ordinarily used. A spattering method and CVD method can be mentioned but not specifically limited. Appropriate methods may be employed. For example, film forming methods ordinarily used including vacuum deposition method, ion plating, sol-gel method, spraying method, spin coating method, CVD, and liftoff may be applicable.

Materials of the organic semiconductor 56 may be any organic materials having semiconductor property, such as pentacene and is not specifically limited thereto. There are included phthalocyanine series derivative, naphthalocyanine series derivative, azo-compound series derivative, perylene series derivative, indigo series derivative, quinacridone series derivative, polycyclic quinon series derivative such as anthraquinone, cyanine derivative, fullerene series derivative, or nitrogen-containing cyclic compound derivatives including indole, carbazole, oxazole, inoxazole, thiazole, imidazole, pyrazole, oxaadiazole, pyrazoline, thiazole, and triazole; quinine compound derivative including hydrazine derivative, triphenylamine derivative, triphenylmethane derivative, stilbenes, and anthraquinonediphenoquinone; and cyclic aromatic compound derivative including anthracene, pyrene, phenanthrene, and coronene; and those having structure in which they are used in main chains in polymers or combined in the pendant form as a side chain, such as polytethylene chain, polysiloxane chain, polyether chain, polyester chain, polyamide chain, and polyimide chain; or carbon series conjugated polymer such as complex type conjugated polymer having the structure in which constituent unit of conjugated polymers is alternately combined and the conjugated polymers includes aromatic series conjugated polymer such as polyparaphenylene, aliphatic series conjugated polymer such as polyacetylene, heterocyclic conjugated polymer such as polypynole and polythiophene, heteroatom-containing conjugated polymer such as polyaniline and polyphenylene sulfide, and conjugated polymer such as poly(phenylenevinylene), poly(anilenevinylene) and poly(chenilenevinylene). Further it is possible to also use polymers having a structure that carbon series conjugated structure is alternately chained with oligosilane such as disilanilen carbon series conjugated polymer structure such as polysilane and disilanileneallylene polymer, (disilane)ethenilenepolymer, and (disilanylene) ethynilenepolymer. Besides, it is possible to also use polymer chain made of inorganic element such as phosphorous series and nitrogen series, polymers coordinated with aromatic ligand of polymer chain such as phthalocyanatpolysiloxane, polymer in which perylene such as perylenetetracarboxylic acid is condensed by heat treatment, ladder type polymers which are obtained by heat-treating polyethylene derivative having cyano group such as polyacrylonitrile, and complex materials in which provskite is intercalated with organic compound.

As a method for manufacturing the organic semiconductor 56, a vacuum deposition method is mentioned, and it is not specifically limited thereto. An appropriate method may be employed. For example, ordinary thin film forming methods including ion plating, sol-gel method, spraying method, and spin coating method may be applicable.

Although the present embodiment employs the organic TFT 50 as a driving element of the organic EL element 100, it is not limited thereto and the other transistors may be employed. Further in case of a passive method, it is unnecessary to use transistors in some cases.

### <Sealing Film>

Although organic films and inorganic films are used in combination for the sealing film in the present embodiment, inorganic films alone may be used. The sealing film is one type of protection films.

As an inorganic film, for example, nitride film, oxide film, carbon film, or silicon film may be used. More specifically, there are included a silicon nitride film, silicon oxide film, silicon oxide nitride film, or diamond-like carbon (DLC) film, amorphous carbon film. That is nitride such as SiN, AlN, GaN, oxides such as SiO, Al₂O₃, Ta₂O₅, ZnO, GeO, oxide nitride such as SiON, carbide nitride such as SiCN, metal fluoride, and metal film. Here an amorphous silicon film is preferably used.

As an the organic film, a furan film, pyrrole film, thiophene film, or polymerized film such as polyparaxylene film epoxy resin, acrylic resin, polyparaxylene, fluoroine polymer (perfluoroolefin, perfluoroether, tetrafluoroethylene, chlorotrifluoroethylene, dichlorodifluoroethylene), metal alkoxido (CH₃OM, C₂H₅OM), polyamide precursor, peril compound are exemplified.

As for the sealing film 20, a laminated structure composed of two or more kinds of materials, a laminated structure of inorganic sealing films, silane coupling layer, a laminated structure of resin sealing films, barrier layers formed of inorganic materials, a laminated structure of cover layers of organic materials, compounds of organics and semiconductor or metals such as Si—CXHY, a laminated structure of inorganics, a laminated structure in which inorganic films and organic films are alternately laminated, a laminated structure where SiO₂ or Si₃N₄ is laminated on a Si layer are exemplified.

In the barrier film 12 and the sealing film 20, the component organic film fills in pinholes and surface unevenness formed in the inorganic film to level the surface. It also functions to reduce film stress.

As a method of manufacturing the sealing film 20, a spattering method and CVD method are mentioned. It is not limited thereto, and an appropriate method may be selected. For example, ordinary thin-film forming methods such as film vacuum deposition, ion plating, sol-gel method, spraying method, spin coating method, and CVD may be also applicable.

With regard to a method of manufacturing each of organic the EL element 100 and the organic TFT 50 in the organic EL display device P, for example, printing methods including gravure coating, gravure reverse coating, comma coating, die coating, lip coating, cast coating, roll coating, air-knife coating, mayer bar coating, extrusion coating, offset, ultraviolet cure offset, flexo, hole plate, silk, curtain flow coating, wire bar coating, revere coating, gravure coating, kiss coating, blade coating, smooth coating, spray coating, flow coating, and brush coating may be applicable. A lower layer is formed as a dried coating film and then the layer is coated over. Further, the lower layer and the upper layer may be doubly laminated in wet condition and subsequently dried.

### <Luminescence Mode of the Organic EL Display Device>

Luminescence mode of the above-mentioned organic EL display device P is described.

When voltage is applied between the gate electrode 52 and the source electrode 58, electron holes are generated on the interface (area about several nm) between the organic semiconductor 56 and the gate insulation film 54. When voltage is applied between the source electrode 58 and the drain electrode 60 after the electron holes are generated, the electron holes can be transported. On the other hand, if voltage is not applied between the source electrode 58 and the gate electrode 52, the electron holes are not transported. Thus, switching is realized in use of a non-conduction state (switch off)and a conduction state (switch on).

Holes (electron holes) are supplied from the source electrode 58 to the drain electrode 60 through the gate insulation film 54. The electrode holes are transferred to the positive electrode 14 of the organic EL element 100 through the drain electrode 60.

In the organic EL element 100, the electron holes are transported from the positive electrode 14 to the electron hole injection layer 162 of the organic solid layer 16. The electron holes thus transported are injected into the electron hole transport layer 164. The electron holes thus injected into the electron hole transport layer 164 are transported into the luminescent layer 166.

Further, in the organic EL element 100, electrons are injected from the negative electrode 18 into the electron injection layer 16 of the organic solid layer 162. The electrons thus injected are transported to the electron transport layer 167. The electrons thus transported are transported to the luminescent layer 166.

The electron holes and electrons thus transported are recombined in the luminescent layer 166. Luminescence is emitted by energy generated during the recombination. This luminescence is conducted toward outside through the electron hole transport layer 164, the electron hole injection layer 162, the positive electrode 14, the barrier film 12 and the substrate 10 in respective order so that the luminescence becomes visible.

In a case where Al is used as the negative electrode 18, the interface between the negative electrode layer 18 and the electron injection layer 168 becomes a reflecting surface on which they are reflected and proceed to the side of the positive electrode 14 and penetrate the substrate 10 to be outwardly emitted. Therefore, when the organic EL element having the above configurations is employed for displays, a side of the substrate 10 becomes a viewing surface.

For example, in a case where full color display is realized with the organic EL panel, there are mentioned a manufacturing method that the organic element emitting each color light of RGB are separately coated (separate coating method), a method that an organic EL element emitting single white color and a color filter (color filter method) are combined, a method that an organic EL element emitting a single color such as blue or white and a color converting layer are combined (color converting method), and a method that a single color organic element realizes multiple luminescence by injecting electromagnetic wave to the organic luminescent layer and others (photo bleaching method). However, they are not specifically limited thereto.

### [Protection Film Manufacturing Method]

A method of manufacturing a protection film in the present embodiment is described by exemplifying a method manufacturing a barrier film 12 shown in FIGS. 4 to 10.

First, an inorganic film 120 is formed on a substrate 10 as shown in FIG. 4.

As a method of manufacturing the inorganic films, there are mentioned a spattering method and CVD method. However, they are not limited thereto, and an appropriate method may be employed. For example, ordinary thin-film forming methods such as film vacuum deposition, ion plating, sol-gel method, spraying method, and CVD may also be applicable.

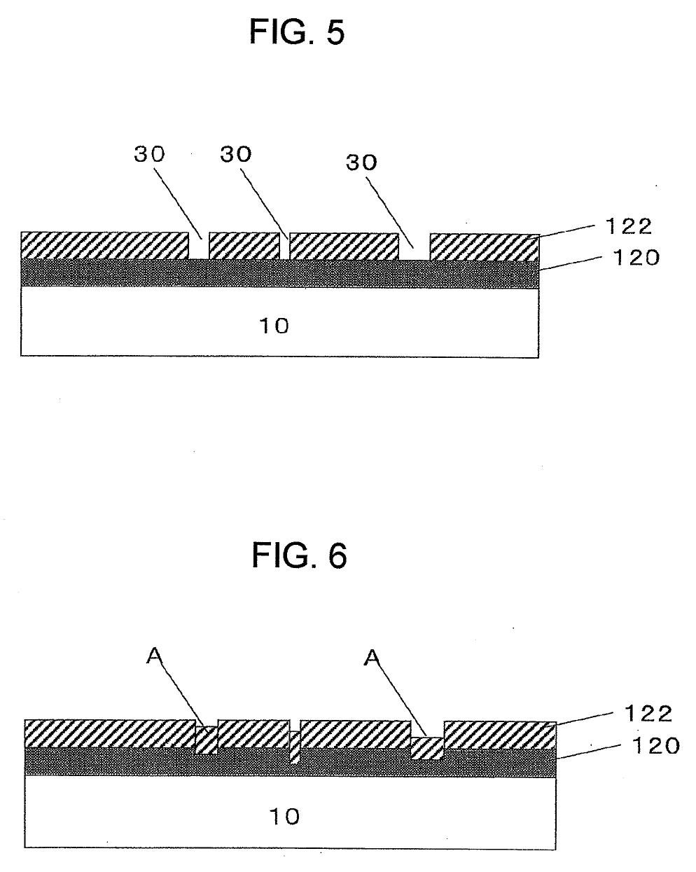

Next, after the inorganic film 120 is formed as in FIG. 5, an already-oxidized inorganic film 122 is formed on the inorganic film 120. The already-oxidized inorganic film 122 may be completely oxidized and may be incompletely oxidized as well. Even though it is incompletely oxidized, it can be oxidized later by oxidation treatments described below. Plural minute pinholes 30 exist in the already-oxidized inorganic film 122. There are a variety of types of pinholes but vertical through type pinholes are described in the drawings.

Next, the inorganic film 120 is oxidized. Inorganic films to be oxidized may be suitably selected and is used as long as they are incompletely oxidized. That is, inorganic films are usable except for completely oxidized inorganic films, not to be oxidized any longer. However, incompletely oxidized inorganic films may be used.

Silicon series films particularly amorphous silicon films are preferable as an inorganic film to be oxidized. The preferable inorganic films are appropriately selected based on relation of materials between inorganic films to be oxidized (inorganic film 120 in the present embodiment) and films subjected to implanting pinholes (inorganic film 122 in the present embodiment). It is preferable to use amorphous silicon film as the inorganic film 120 and silicon series nonoxide inorganic film such as SiN, SiO, SiON, SiCN (more preferably, SiO, SiN, SiON) is used for the inorganic film 122 because they are common as silicon material.

An oxidation method is not specifically limited thereto but methods may be suitably selected and used as long as width and numbers of pinholes are reduced. For example, electrical oxidation such as heat oxidation and anode oxidation, plasma oxidation method (including plasma oxidation in narrow meaning and plasma nitridation method), plasma oxidation method such as plasma anode oxidation, and wet anode oxidation method may be employed.

Particularly the electrical oxidation method and the plasma oxidation method are preferable because inorganic films is oxidized at low temperature due to supplementary plasma energy and electrical energy. Thus low temperature oxidation advantageously enables to prevent substrates and elements from being heated thereby reducing damage caused by heat.

With respect to oxidation conditions, a person ordinarily skill in the art can appropriately select conditions depending on respective oxidation methods. A case where amorphous silicon films are used as inorganic films e.g. by the plasma oxidation method is exemplified. In a case where ECR plasma is used as plasma, oxygen plasma is generated by RF electric discharge and the amorphous silicon film i.e. inorganic film 120 is oxidized under conditions where oxygen/argon:200/20 sccm, pressure: approximately 10 m Torr, anode current: 300 mA, RF:100 W, temperature: room temperature to 400° C. or less, preferably 200° C. or less.

With respect to the plasma oxidation method, the above-mentioned ECR plasma may be used, but it is not limited thereto and other methods may be suitably selected and used. For example, a method using surface wave plasma and MMT plasma, known as high density plasma, may be employed. For example, a plasma anode oxidation method which combines the plasma oxidation method and the anode oxidation method may also be employed.

With respect time for oxidizing an inorganic film which is not completely oxidized like the inorganic film 120, the time may be suitably selected without being specifically limited as long as oxidation is performed after the film is formed. It is preferable that an already-oxidized inorganic film (inorganic film 122 in the present embodiment) subjected to implanting pinholes is formed adjacent to the surface of the inorganic film (inorganic film 120 in the present embodiment) to be oxidized and subsequently oxidized.

If the inorganic film 120 is thus oxidized after the inorganic film 122 is formed, the inorganic film 122 is oxidized and develops the pinholes 30 which are generated in the inorganic film 122, and the inorganic film 120 is oxidized and develops in addition to the pinholes generated in the inorganic film 120 itself. Therefore width of the pinholes 30 in the adjacent inorganic film 122 can be reduced in such manner that the pinholes 30 of the inorganic film 122 are implanted. Further, the pinholes 30 are completely covered in so that the number of pinholes can be reduced in some cases.

In the present embodiment a plasma oxidation method is employed as an example. In the plasma oxidation method, plasma oxidation is conducted on the inorganic film 122, oxidation factors (such as oxygen plasma) reach a surface corresponding to pinholes 30 of the lower-level inorganic film 120 through the pinholes of the inorganic film 122, and the surface of the inorganic film 120 corresponding to the pinholes 30 of the inorganic film 122 is oxidized, so that the inorganic film 120 is oxidized to develop as shown in A of FIG. 6. Width of the pinholes of the adjacent inorganic film 122 can be reduced in such manner that pinholes of the inorganic film 122 are implanted by oxidation development A of the inorganic film 120. Pinholes are sometimes completely covered and the number of pinholes can be reduced.

Meanwhile, using with the already oxidized inorganic film (inorganic film 122 in the present embodiment) in combination as mentioned above is preferable, but it is not limited thereto. The other configuration in which an inorganic film to be oxidized (inorganic film 120 in the present embodiment) is used alone or used in combination with the other inorganic films and organic films may be applicable.

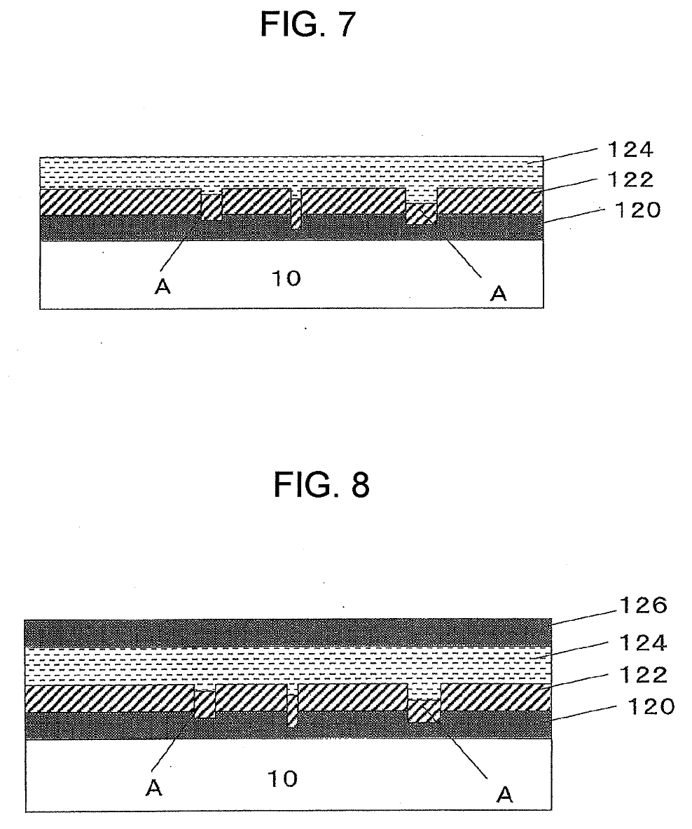

Next, an organic film 124 is formed on the inorganic film 122 as shown in FIG. 7.

With respect to methods of forming the organic film, there may be employed a plasma polymerization method, as an organic film vapor-phase development method, using gas containing organic monomer such as methane and ethylene as a raw material to decompose in use of polymerized utilizing plasma. There also may be employed a method of coating ultraviolet cure type resin and thermoset resin by a spin coating method and thereafter curing it to form solid film. However, the method is not limited thereto and other methods may be appropriately employed. In the present embodiment, a resin film is used as the organic film. By providing the resin film, it is possible to obtain smoothness in pinholes and surface of inorganic film and to reduce film stress of the inorganic film.

In coating by the spin-coating method, there may be employed a method of spin-coating organic film materials by dissolving a precursor in a single or plural kinds of solvents selected from solvents including toluene, benzene, chlorobenzene, dichlorobenzene, chloroform, tetralin, xylene, anisole, dichloromethane, γ butyrolactone, butylcellosolve, cyclohexane, NMP(N-methyl-2-pyrolidone), dimethylsulfoxide, cyclohexanon, dioxane, or THF(tetrahydrofuran), PGME(propylene glycol monomethy ether), PGMEA(propylene glycol monomethyl ether acetate), ethyle lactate, DMAc (N, N-dimethylacetamide), MEK(methyl ethyl ketone), MIBK(methyl isobutyl ketone), IPA(isopropyl alcohol) and ethanol. In the case of nonsolvent coating, use of these solvents is unnecessary as a matter of course. Although the organic film is preferable because it is effective for stress reduction and pinhole implantation, the inorganic film may be used alone without using the organic film.

Next, as shown in FIG. 8, the inorganic film 126, which is not completely oxidized, is formed on the organic film 124. Before the inorganic film 126 is formed, a surface of the organic film 124 may be treated.

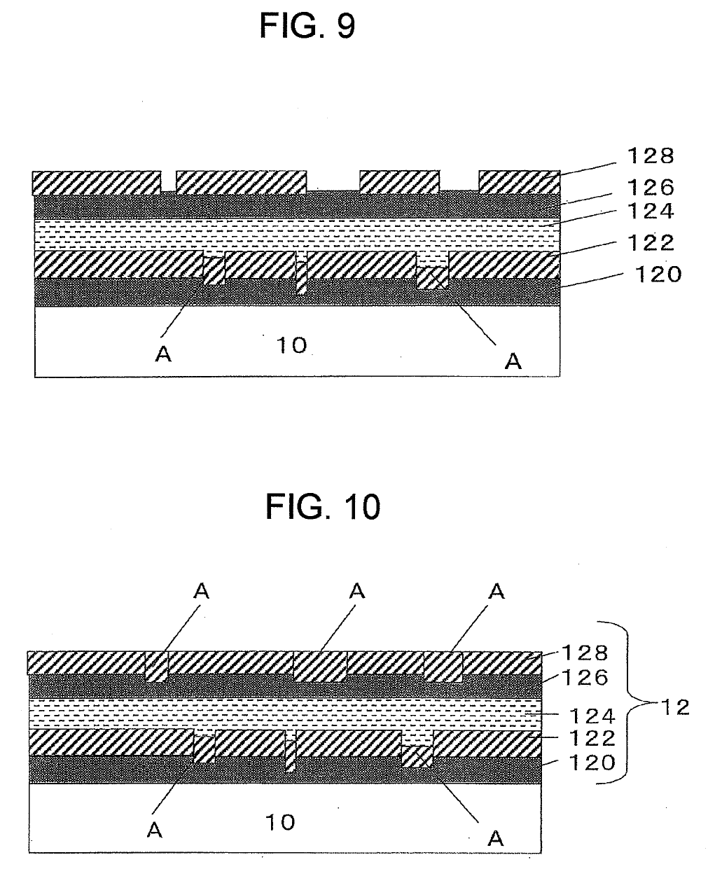

Next, as shown in FIG. 9, after the inorganic film 126 is formed, the inorganic film 128 is formed on a surface thereof in a manner similar to the inorganic film 122 is formed with respect to the inorganic film 120. After the inorganic film 128 is formed, the inorganic film 126 beneath the inorganic film 128 is oxidized. Pinholes of the inorganic film 128 are implanted as shown in FIG. 10 in a manner similar to the oxidation treatment of the inorganic film 122 as explained in FIG. 6 and others, thereby reducing width of the pinholes. In some cases, the pinholes are completely covered to reduce the number of the pinholes. The barrier film 12 is formed on the substrate 10 by formation of the inorganic film 128. The sealing film 20 is also formed in a manner similar thereto.

In the present embodiment, even if density of the inorganic film is not sufficient and pinholes are partly generated, the density of the inorganic film can be improved in a later stage. Therefore, elements can be prevented from being damaged because the element surface is prevented from penetration of moisture, oxygen and the like into the element surface from outside through the pinholes, generated in the inorganic film. The effects of this prevention are obtainable irrespective of variety of pinhole types (e.g. vertical penetration type and oblique penetration type).

Although the above-mentioned embodiment is described with respect to the barrier film 12 for convenience of explanation, the present invention is not limited thereto. The present invention is applicable to ordinary protection films and further ordinary inorganic films. Needless to say that, the present invention is also applicable to the sealing film 20 in the above-mentioned embodiment. It is not limited thereto and is applicable to a method of manufacturing protection films for protecting ordinary elements which are employed in organic solar cells and displays. The displays are not limited to organic EL display devices and semiconductor lasers, and ordinary displays such as liquid crystal displays, electricphoretic-type displays, electronic paper, and toner displays may be used. The elements may be ordinary transistors (e.g. CNT-FET), ordinary circuit elements such as diode, capacitance, and composition semiconductors.

In the present embodiment, although the protection film is exemplified, ordinary inorganic films as inorganic films forming elements may be used. For example, it can be used as the gate insulation film 54 of the above-mentioned organic TFT 50 and further as a gate insulation film of silicon MOSFET. In silicon MOSFET, since density of the silicon films and pinholes are not sufficient due to film thinning of the gate insulation film, a gate leak current tends to be generated in some cases. In such the cases, pinholes may be implanted by the present inorganic film manufacturing method to improve density, so that leakage of the gate leak current can be preferably prevented.

1. A method of manufacturing a protection film that protects elements and contains at least one layer of oxidized inorganic film, comprising:
a pre-oxidized inorganic film formation step of forming a pre-oxidized inorganic film which is not completely oxidized;
a step of forming an organic film or an inorganic film, which is respectively adjacent to and independent of the pre-oxidized inorganic film; and
an inorganic film oxidation step of oxidizing a surface corresponding to the pre-oxidized inorganic film through pinholes existing in the inorganic film or the organic film to thereby form the oxidized inorganic film.

2. (canceled)

3. The method of manufacturing the protection film according to claim 1, wherein an already oxidized inorganic film which is previously oxidized is used as the inorganic film.

4. The method of manufacturing the protection film according to claim 3,
wherein the already oxidized inorganic film is a silicon type inorganic film.

5. The method of manufacturing the protection film according to claim 1,
wherein the oxidized inorganic film is formed on a surface on an element side of the protection film or on an opposite side to the element side in the inorganic oxidation step.

6. The method of manufacturing the protection film according to claim 1,
wherein the pre-oxidized inorganic film is a silicon type inorganic film.

7. The method of manufacturing the protection film according to claim 6,
wherein the silicon type inorganic film is made of amorphous silicon.

8. The method of manufacturing the protection film according to claim 1,
wherein the element is at least either one of an organic EL element and an organic transistor.

9. A method of manufacturing an inorganic film which includes at least one layer of oxidized inorganic film, comprising:
a pre-oxidized inorganic film formation step of forming a pre-oxidized inorganic film which is not completely oxidized;
a step for forming an inorganic film or an organic film, which is respectively adjacent to and independent of the pre-oxidized inorganic film; and
an inorganic film oxidation step of oxidizing a surface corresponding to the pre-oxidized inorganic film through pinholes existing in the inorganic film or the organic film to thereby form the oxidized inorganic film.

10. (canceled)
